(19) United States
(12) Patent Application Publication
(10) Pub. No.: US 2025/0077928 A1
(43) Pub. Date: Mar. 6, 2025

(54) GENERATION OF QUANTUM CONTROL PULSES AND RELATED SYSTEMS

(71) Applicant: Massachusetts Institute of Technology, Cambridge, MA (US)

(72) Inventors: Agustin Di Paolo, Cambridge, MA (US); William D. Oliver, Lexington, MA (US)

(73) Assignee: Massachusetts Institute of Technology, Cambridge, MA (US)

(21) Appl. No.: 18/590,218

(22) Filed: Feb. 28, 2024

Related U.S. Application Data
(60) Provisional application No. 63/488,198, filed on Mar. 3, 2023.

(51) Int. Cl. G06N 10/60; G06N 10/40

(52) U.S. Cl. CPC G06N 10/60; G06N 10/40

(57) ABSTRACT

Described is an optimal-control system and method provide an efficient routine for differentiating the most general Unitary, Liouville, or Monte-Carlo Schrödinger equation associated with the control problem of interest.

### CROSS-REFERENCE TO RELATED APPLICATIONS

This application claims the benefit of U.S. Provisional Application No. 63/488,198 filed on Mar. 3, 2023 of which is hereby incorporated herein by reference in its entireties.

### STATEMENT REGARDING FEDERALLY SPONSORED RESEARCH

This invention was made with government support under W911NF-18-1-0411 awarded by the U.S. Army Research Office. The government has certain rights in the invention.

### PARTIES TO A JOINT RESEARCH AGREEMENT

Not applicable.

### FIELD

The disclosure pertains generally to engineering controls for quantum logical operations such as one- and two-qubit gates, and more particularly to optimizing the quantum control pulses for superconducting qubits.

### BACKGROUND

Superconducting quantum circuits are a leading hardware architecture for quantum computing. One task in the design of a superconducting quantum processor is the definition of two-quantum bit (qubit) interactions and control pulses to implement logical operations (e.g., high-fidelity logical operations), such as two-qubit gates. Quantum optimal control groups a set of theoretical and experimental techniques that can be used to improve the quality of such logical control pulses.

Consider the example of a two-qubit gate coupled between two superconducting qubits. In a typical scenario, the qubits are coupled by a circuit element (hereinafter generally referred to as a “coupling circuit” or more simply a “coupler”), such as a capacitor, inductor, or coupling qubit. To perform a two-qubit gate, a voltage and/or current pulse is applied to the qubits and/or the coupler. In most cases, the amplitude and/or the frequency of the control pulse as a function of time follows a waveform having a particular shape, such as a Gaussian function. Quantum optimal control may be applied to improve the two-qubit gate performance by refining the pulse shape according to a cost function (such as gate infidelity, for example) to be minimized.

Gate infidelity can be computed numerically and minimized using gradient-based or gradient-free methods. Gradient descent uses the cost function's gradient with respect to pulse parameters to improve the pulse shape via parameter corrections introduced at each minimization step. However, in most cases the gradient of the cost function is not known, and needs to be numerically approximated by a technique such as finite differences. Approximation, however, is a computationally expensive workaround since it requires computing the gradient of the cost function, which integrates the Schrödinger equation associated with the control problem and requires evaluating such a function as many times as the number of pulse parameters.

### SUMMARY OF DISCLOSED EMBODIMENTS

In accordance with one aspect of the concepts sought to be protected, described is a quantum optimal control (QOC) method. The QOC method includes modeling a quantum mechanical process having one or more time-dependent parameters, constructing a Fourier representation of the time-dependent parameters to determine one or more fundamental frequencies, forming a time-independent Hamiltonian from quantum-mechanical operators derived from the fundamental frequencies, solving, in closed form, a time-independent Schrödinger equation that includes the Hamiltonian, forming an electromagnetic pulse according to the closed-form solution, wherein the electromagnetic pulse optimizes a cost function of the time-dependent parameters; and applying the electromagnetic pulse to the quantum mechanical process, thereby altering at least one observable property of the quantum mechanical process.

With this particular arrangement, the QOC method described herein utilizes a control Hamiltonian is not linear in the pulse parameters and provides access to an exact gradient (and to higher-order derivatives if needed) of the Schrödinger equation. No other quantum-optimal-control method leading to an exactly differentiable form of the stochastic Schrödinger equation is known.

This is in contrast to prior art methods which assume the control Hamiltonian is linear in the pulse parameters and which only have access to an approximate derivative of Schrödinger equation or to an exact derivative of an approximated Schrödinger equation.

Furthermore, since many practical control problems are nonlinear, the ability to handle nonlinear control is thus a unique and very useful property of the QOC method described herein. One example of a nonlinear control problem is baseband-flux control of transmon qubits used to implement two-qubit gates.

Moreover, the QOC method described herein avoids the need for rotating-wave approximations.

Since methods which make use of rotating-wave approximations are limited in generality, avoiding the use of rotating-wave approximations is a significant benefit of the QOC method described herein when compared to other methods since the approach QOC method described herein is more general than prior art methods.

Thus, the generality of the QOC method described herein makes it possible to work with the complete Schrödinger equation and to optimize fast controls for which methods utilizing rotating-wave approximations fail. This is important for optimizing fast, state-of-the-art two-qubit gates.

Another advantage of the method described herein is that computing the gradient of the cost function with respect to an arbitrary number of parameters requires only a single evaluation of the cost function and a matrix multiplication operation per parameter. The latter is easily parallelizable in a multi-core machine. Thus, the method described herein can be implemented in a highly parallel fashion.

Another advantage of the method described herein is that convergence to a unit-fidelity quantum logical operation (up to an exponentially small tolerance) is found to be exponentially fast in the number of parameters that define the control pulse. This makes it possible to find efficient parametrizations (order 10 parameters) for most superconducting-qubit gates with sufficiently high (>99.99%) gate fidelities.

Another advantage of the method described herein is that the method leads to a differentiable Liouville-Schrödinger equation. This makes it possible to handle the most general case of the control problem, including dissipation.

Another advantage of the QOC method described herein is that the method also leads to a differentiable version of the stochastic-wavefunction equation associated with the driven problem, where a non-Hermitian Hamiltonian and collapse operators are used to take dissipation into account. Because the stochastic-wavefunction equation method scales much better than the Liouville-Schrödinger equation, a differentiable Monte-Carlo method is highly valuable.

Further still, the QOC method described herein allows computation of gradients (including numerically exact computation of gradients) with respect to any parameter of the Schrödinger equation, including not only pulse parameters but also device parameters such as qubit energies and two-qubit couplings. This makes gradient-based optimization much more efficient in the multi-parameter case, as the number of evaluations of the expensive cost function does not scales with the number of parameters when the gradient can be computed exactly, i.e. no need for finite-difference approximation.

The described QOC method is based, at least in part, upon the inventors recognition that gate dynamics of a desired quantum computer can be inscribed into a time-periodic problem, where the fundamental period is a gate time and the fact that the Schrödinger equation associated with a time-periodic driven problem can be solved by diagonalizing an associated Floquet Hamiltonian, and the resulting Floquet time-propagator is exactly differentiable. The inventors have also recognized that gate dynamics with a time-periodic parametrization of the controls is exactly differentiable if solved in a Floquet representation.

To arrive at an quantum optimal control method, the original time-dependent problem is represented as a Floquet Hamiltonian. This can be done by first parameterizing the control(s) using a Fourier representation with potentially several fundamental frequencies (i.e., as a multi-tone Floquet problem), and then promoting the control-drive degrees of freedom to a quantum-mechanical operator representation. These steps remove the explicit time-dependence of the Schrödinger equation associated with the original control problem, defining a new, time independent differential equation that can be solved by diagonalizing the Floquet Hamiltonian in an expanded Hilbert space.

As noted, the QOC method described herein does not require any of the approximations that are introduced in other quantum-optimal-control routines, such as the so-called “rotating-wave” approximation.

Thus, the generality of the approach described herein is particularly useful to optimize two-qubit gates that that operate at the speed limit set by the interaction strengths and quantum control of low-frequency qubits (i.e., qubits for which the gate time is comparable to the qubits' self-energy) given that a rotating-wave approximation is not possible in such a case.

Furthermore, the techniques described herein may be used to simulate open-system dynamics in the presence of dissipation, developing both deterministic and stochastic differentiable solvers of the Lindblad master equation (or Liouville equation) associated with the control problem.

The above-described QOC method has been numerically implemented and used to significantly improve the performance of the following gate configurations:
1. faster-than-the-qubit-frequency single-qubit gates for fluxonium qubits (e.g., of the type disclosed in H. Zhang et. al, Phys. Rev. X 11, 011010 (2021));
2. microwave two-qubit controlled-Z gates for transmon qubits (e.g., of the type disclosed in K. X. Wei et. al, Phys. Rev. Lett. 129, 060501 (2022));
3. Baseband-flux two-qubit controlled-Z gates for transmon qubits (e.g., of the type disclosed in M. A. Rol et al., Phys. Rev. Lett. 123, 120502 (2019)); and
4. Baseband-flux two-qubit “pulse-train” controlled-NOT (CNOT) gates for fluxonium qubits.

In each of the above cases, it has been found that using the techniques described herein, gate fidelity reaches values above 99.99% (gate infidelity below 0.01%) in gate times that are only 25-50% of gate times typically required for the above-mentioned gate configurations with Gaussian and other simple pulses. Stated differently, the QOC method described herein allows operation of these gate configurations close to the speed-limit defined by the two-qubit interaction strength without compromising (and ideally, improving) gate fidelity, while in absence of this method, leakage transitions limit the gate speed significantly before reaching the theoretical speed limit.

In the case of some gates described herein, a proposed pulse-train parametrization comprises a differentiable building-block pulse of time t_{bb} that is concatenated with itself N times to complete the gate in a total time N*t_{bb} where n is a parameter that would typically range between 5-50, and its value can be optimized heuristically on a case-by-case basis. This pulse parametrization is new and highly successful at enabling two-qubit gates for fluxonium qubits in the high-coherence and low-frequency regime, for which no other two-qubit gates with good performance are known.

It is appreciated that the concepts, techniques, and structures disclosed herein may be embodied in other ways, and that the above summary of disclosed embodiments is thus meant to be illustrative rather than comprehensive or limiting. In particular, individual elements of different embodiments described herein may be combined to form other embodiments not specifically set forth above. Various elements, which are described in the context of a single embodiment, also may be provided in other embodiments separately, or in any suitable sub-combination. Moreover, other embodiments not specifically described herein also may be within the scope of the claims set forth below.

The optimal-control system and method described herein enables controlling superconducting qubits with the highest fidelity possible while also being qubit-architecture independent. The described optimal-control system and method thus represents a general solution to a problem in superconducting quantum computing. Accordingly, the described optimal-control system and method is suitable for integration into pulse-design workflows for quantum logical operations in industrial settings.

### DESCRIPTION OF THE SEVERAL VIEWS OF THE DRAWINGS

The manner and process of making and using the disclosed embodiments may be appreciated by reference to the drawings, in which:

FIG. 1 is a flow diagram of a method for generating one or more quantum control pulses;

FIG. 2 is a schematic diagram of an example system for generating one or more quantum control pulses and applying one or more quantum control pulses to a quantum system;

FIG. 3A is a plot of amplitude vs. time for a microwave pulse signal;

FIG. 3B is a flow diagram of an example method for optimizing pulses and qubit gates;

FIG. 4A is a plot of amplitude vs. time for an example baseband pulse signal;

FIG. 4B is a flow diagram of an example method for optimizing pulses and qubit gates;

5A is a schematic diagram of a system illustrating a two-tone drive signal for gating a weakly anharmonic transmon qubit;

FIG. 5B is a plot of frequency/drive frequency (f_{drive}) vs. Gauge-inv phase ϕ for the system of FIG. 5A;

FIG. 5C is a plot of gate infidelity as a function of the number of harmonics for the system of FIG. 5A;

FIG. 5D is a spectral representation of a pulse for the system of FIG. 5A;

FIG. 5D illustrates the amplitude of each harmonic at a given frequency. As can be seen in FIG. 5D,

FIG. 5E is a schematic diagram of an example system comprising two transmon qubits coupled by a capacitor;

FIG. 5F is a schematic diagram of an example pulse which may be applied to transmon qubits in the example system of FIG. 5E;

FIG. 5G is a diagram which illustrates the two-tone Floquet problem.

FIG. 6A is a plot of average gate infidelity vs. the number of optimizer iterations for a first one of the pair of qubits in the system of FIG. 5E;

FIG. 6B is a plot of adaptive learning rate vs. the number of optimizer iterations for a second one of the pair of qubits in the system of FIG. 5E;

FIG. 6C is a plot of drive amplitude vs. gate time for a first one (QB1) of the pair of qubits in the system of FIG. 5E;

FIG. 6D is a plot of drive amplitude vs. gate time for a second one (QB2) of the pair of qubits in the system of FIG. 5E;

FIG. 6E is a plot of change in carrier frequency (Δω₂/2π) vs. the number of optimizer iterations;

FIG. 6F is a sequence of panels illustrating different parameters which can be adjusted during an optimization process in accordance with a method for generating one or more quantum control pulses;

FIG. 7A is a schematic diagram illustrating two directly coupled fluxonium qubits;

FIG. 7B is a schematic diagram illustrating a series of concatenated pulses for a 2 qubit gate scheme such as the two directly coupled fluxonium qubits of FIG. 7A;

FIG. 8A is a plot of average gate infidelity vs. the number of optimizer iterations for a first one (QB1) of the pair of qubits in the system of FIG. 7A;

FIG. 8B is a plot of adaptive learning rate vs. the number of optimizer iterations for a second one (QB2) of the pair of qubits in the system of FIG. 7A;

FIG. 8C is a plot of flux amplitude vs. gate time for a first one (QB1) of the pair of qubits in the system of FIG. 7A;

FIG. 8D is a plot of flux amplitude vs. gate time for a second one (QB2) of the pair of qubits in the system of FIG. 7A;

FIGS. 9A, 9B illustrate complete pulses resulting from a series of concatenated pulses for a 2 qubit gate scheme such as shown in the system of FIG. 7A;

FIG. 9C is a plot of state population vs. gate time for a 2 qubit gate scheme such as shown in the system of FIG. 7A; and

FIG. 9D is a plot of both single block time and drive frequency vs a number of optimizer iterations.

### DETAILED DESCRIPTION OF EMBODIMENTS

Described herein are concepts and techniques related to quantum optimal control (QOC) methods and systems.

In one aspect, described is a method to solve the Schrödinger equation associated with an optimal control problem using Floquet theory. This method also leverages a convenient parametrization of the control pulses based on a time-periodic series expansion of choice. Importantly, the numerical approach described herein provides access to an efficient and exact form of the gradient of the gate infidelity, which is used in a gradient-descent technique to iteratively optimize a pulse shape.

The method described herein does not require use of any of the approximations introduced in other quantum-optimal-control routines, such as the so-called “rotating-wave” approximation. This generality makes the technique described herein particularly useful to optimize fast two-qubit gates and quantum control of low-frequency qubits for which the gate time is comparable to the qubits' self-energy. Furthermore, the formulation can and has been expanded to simulate open-system dynamics in the presence of dissipation, developing both deterministic and stochastic differentiable solvers of the Lindblad master equation (or Liouville equation) associated with the control problem.

In general overview, described are a quantum optimal control (QOC) method and system to generate and apply optimal control signals (i.e., quantum control pulses such as one or more (e.g., a sequence) electromagnetic pulses) for quantum logical operations such as single quantum bit (qubit) and two-qubit gates. The concepts described herein are directed toward optimizing quantum control pulses for superconducting qubits alongside device parameters, including baseband and microwave driving, using a Fourier-series parametrization of the pulse shape and an exactly differentiable numerical solution of the Schrödinger equation. Also described is a version of two-qubit gates based on concatenating a (differentiable) train of pulses.

In this specification, including the appended claims, the following quoted terms shall have the indicated meanings that are not limited to specific embodiments, except where expressly indicated otherwise:

“Quantum optimal control theory” (QOCT) or more simply “quantum optimal control” (QOC) refers to methods that manipulate quantum dynamical processes at the atomic or molecular scale using external electromagnetic fields that are devised and shaped to improve or ideally optimize a chosen process parameter,

In accordance with the concepts sought to be protected herein, the inventors have recognized that all time-periodic dynamics are exactly differentiable and all quantum gate dynamics are time-periodic. All gate dynamics can be represented as a periodic problem where the system Hamiltonian evolves from:

H(t=0)→H(t=T)≡H(t=0)

in which:
H is the Hamiltonian
t is time
T is the gate time and also the ‘period’

All time-periodic quantum dynamics can be solved using Floquet theory. Floquet theory provides an exactly differentiable form of a time-evolution operator. These derivatives can be used in a gradient-descent loop to target a specific quantum gate by controlled time-evolution—i.e., a form of quantum optimal control.

The form of the propagator involves time-dependent phases proportional to the quasi-energies ε_{α}^{l} and projectors /ψ_{α}^{l} [symbol] [symbol] ψ_{α}^{l}/generated by eigenstates /ψ_{α}^{l} [symbol] ). Together, these diagonalize the Floquet Hamiltonian H_{F} associated with the (periodic) gate dynamics as follows:

$${H}_{F} = H [ θ ] + ℏ , ω \cdot m \qquad ( 1 )$$

in which:
H is a Hamiltonian;
θ represents drive degrees of freedom;
ℏ represents the reduced plank constant;
ω is a vector of drive frequencies; and
m is a conjugate (photon-number) operator associated with e.
   In this representation, the time-evolution operator reads:

$$U ( 0 \to T ) = 〈 θ ( T ) / {\sum }_{α l} e - i ε l α \vert ψ l α 〉 〈 ψ l α \vert \vert m = 0 〉 \qquad ( 2 )$$

in which
U is the time evolution operator;
T represents time;
θ represents drive degrees of freedom;
α represents a system-state quantum number;
i represents the complex unit;
ε represents an energy eigenvalue of the Floquet Hamiltonian; and
l represents a drive-photon (Floquet) quantum number.

The derivatives of U (0→T) with respect to system and/or drive parameters can be computed by linear-algebra operations involving the Floquet eigenstates. In addition, the structure of the Floquet states makes it possible to compute such derivatives by operating on only N Floquet eigenstates, where Nis the dimension of the system. This allows for an efficient quantum-control algorithm.

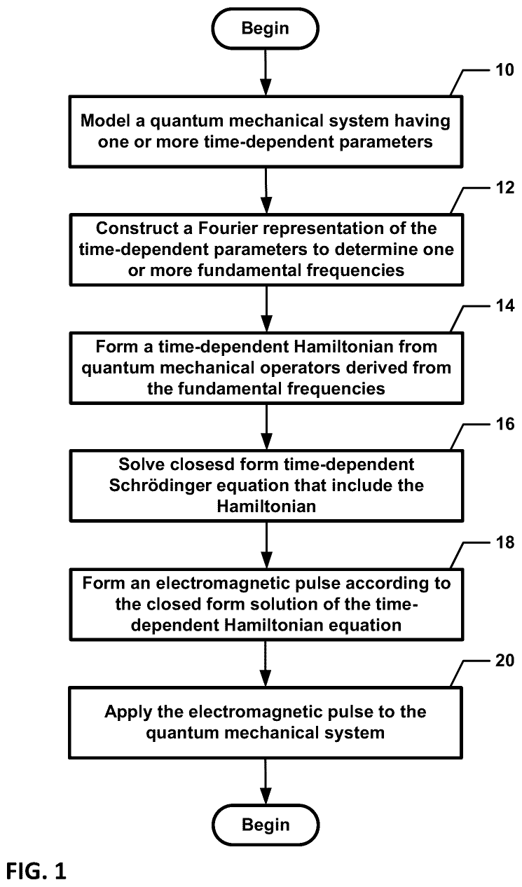

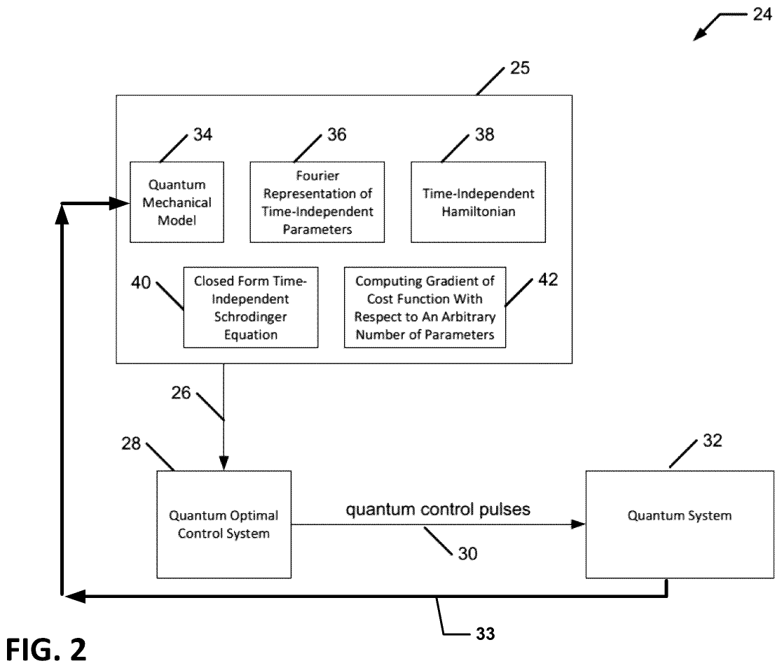

FIG. 1 is a flow diagram showing illustrative processing that can be implemented within a system and, more particularly, within a QOC system, such as the illustrative system described in conjunction with at least FIG. 2. Rectangular elements (typified by element 10), are herein denoted “processing blocks,” and represent processing instructions (e.g., computer software instructions) or groups of instructions. Alternatively, the processing blocks may represent steps or processes performed by functionally equivalent circuits such as a digital signal processor circuit or an application specific integrated circuit (ASIC). The flow diagram does not depict the syntax of any particular programming language, but rather illustrates the functional information one of ordinary skill in the art requires to fabricate circuits and/or generate computer software to perform the described processing. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied without departing from the spirit of the concepts, methods and systems sought to be protected herein. Thus, unless otherwise stated the blocks described below are unordered, meaning that, when possible, the functions represented by the blocks can be performed in any convenient or desirable order.

Turning now to FIG. 1, as shown in processing block 10, a process for generating one or more (e.g., a sequence of) control pulses begins by modeling a quantum mechanical system or process having one or more time-dependent parameters.

In processing block 12 a Fourier representation of the time-dependent parameters is constructed to determine one or more fundamental frequencies of the system being modeled.

In processing block 14 a time-independent Hamiltonian is formed from quantum-mechanical operators derived from the fundamental frequencies.

In processing block 16, a time-independent Schrödinger equation that includes the Hamiltonian is then solved in closed form.

In processing block 18 an electromagnetic pulse is formed according to the closed-form solution obtained in block 16, wherein the electromagnetic pulse has a shape designed to increase (and ideally optimize) a cost function of time-dependent parameters of the closed form Schrödinger equation solution.

As shown in processing block 20, the electromagnetic pulse may be applied to the quantum mechanical system which was modelled. Thus, the applied electromagnetic pulse may alter at least one observable property of a quantum mechanical process performed by the quantum mechanical system.

The described QOC method is based upon at least two facts. First, all gate dynamics can be inscribed into a time-periodic problem, where the fundamental period is the gate time. Second, the Schrödinger equation associated with a time-periodic driven problem can be solved by diagonalizing the associated Floquet Hamiltonian, and the resulting Floquet time-propagator is exactly differentiable. Thus, all gate dynamics with a time-periodic parametrization of the controls is exactly differentiable if solved in the Floquet representation.

To arrive at the optimal control method described herein, the original time-dependent problem must be represented as a Floquet Hamiltonian. This can be done by parameterizing the control(s) using a Fourier representation with potentially several fundamental frequencies (e.g., a multi-tone Floquet problem), and then promoting the control-drive degrees of freedom to a quantum-mechanical operator representation. These steps remove the explicit time-dependence of the Schrödinger equation associated with the original control problem, defining a new, time-independent differential equation that can be solved by diagonalizing the Floquet Hamiltonian in an expanded Hilbert space. A similar procedure can be done for Lindblad and stochastic master equations describing the control problem in the presence of dissipation.

The described quantum optimal control (QOC) method includes several advantages compared with prior art methods. For example, the described QOC technique removes the need for rotating-wave approximations (RWA). This makes it possible to treat driven problems in the limit of strong drive (fast gates). Also, the drive Hamiltonian can be nonlinear in the drive parameters. The QOC method described herein admits a stochastic solution when including dissipation that is also exactly differentiable. This makes it possible to apply optimal control in realistic conditions, including noise channels.

Compared with prior art approaches, the describe QOC method has increased dimensionality of the Floquet Hamiltonian used to optimize the dynamics compared to the system's dimension. When many drives are present in the problem, this dimensionality cost could make the described OQC method intractable. However, the inventors have recognized that most problems within superconducting-qubit gate optimization are tractable.

The method can be and has been applied to various superconducting-qubit setups and novel two-qubit gates. The above concepts and method have been numerically implemented and used to significantly improve the performance of the following gates:
1. Faster-than-the-qubit-frequency single-qubit gates of the type [1] for fluxonium qubits
2. Microwave two-qubit controlled-Z gates of the type [2] for transmon qubits
3. Baseband-flux two-qubit controlled-Z gates of the type [3] for transmon qubits
4. Baseband-flux two-qubit “pulse-train” controlled-NOT gates for fluxonium qubits [4]

In all cases, it has been found that the gate fidelity reaches values above 99.99% (gate infidelity below 0.01%) in gate times that are only 25-50% of the typical gate times required for these setups with Gaussian and other simple pulses. In other words, the QOC method described herein allows operation of these gates close to the speed-limit defined by the two-qubit interaction strength without compromising—and, in fact, improving—gate fidelity. In the case of some gates described below, a proposed pulse-train parametrization comprises a differentiable building-block pulse of time t_{bb} that is concatenated with itself N times to complete the gate in a total time N*t_{bb}. This pulse parametrization is new and highly successful at enabling two-qubit gates for fluxonium qubits in the high-coherence and low-frequency regime, for which no other two-qubit gates with good performance are known.

Referring now to FIG. 2, a system 24 includes a pulse optimizer processing system 25 which may comprise one or more processors which cooperate to generate one or more (e.g., a sequence) of control signals 26 provided to a quantum optimal control (QOC) system 28. QOC system 28 receives the signals provided thereto and in response thereto generates one or more (e.g., a sequence) of quantum control pulses 30 which are provided to a quantum system 32.

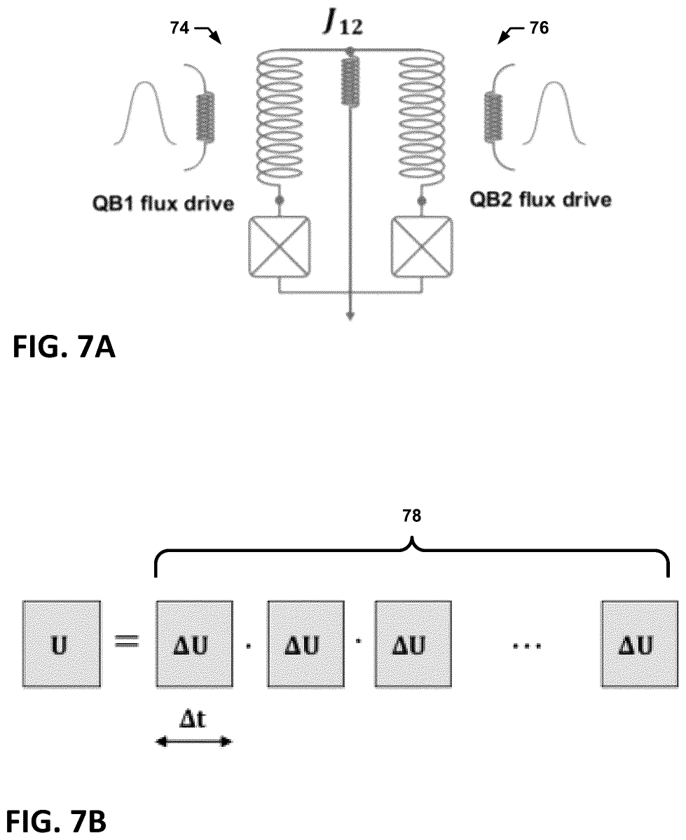

In response to the quantum control pulses provided thereto, quantum system 32 may optionally provide feedback information (e.g. one or more feedback signals) via feedback path 33 to the pulse optimizer processing system 25. In embodiments, a known pulse (e.g. a pulse having known characteristics) may be provided to quantum system 32 as an input. In response to the known input pulse, quantum system 32 generates an output response (e.g. an output signal) which is coupled to (or otherwise provided to) pulse optimizer processing system 25 via feedback path 33. As noted above, in some embodiments the output response of quantum system 32 may be directly provided to the quantum mechanical model 34 while in other embodiments the output response of quantum system 32 may undergo further processing before being provided to quantum mechanical model 34. If the output response of quantum system 32 does not substantially match an expected output response of the quantum mechanical model 34, the quantum mechanical model 34 of system 32 may be modified (or otherwise adjusted or changed) such that the quantum mechanical model 34 provides a desired response (e.g., a response which results in a substantial match to the output provided by the quantum system 32 in response to the known pulse. This may be an iterative process. For example, in embodiments, the same known pulse may be fed to quantum system 32 multiple times and the quantum mechanical model may be adjusted (or otherwise changed or modified) after each of the output responses provided by quantum system 32 or the quantum mechanical model may be adjusted (or otherwise changed or modified) only after selected ones of the output responses provided by quantum system 32. In another example, in embodiments, a sequence of known but different pulses (e.g., a sequence of known pulse, with each pulse in the sequence having different characteristics) may be fed to quantum system 32 and the quantum mechanical model may be adjusted (or otherwise changed or modified) after each of the output responses provided by quantum system 32. Or the quantum mechanical model may be adjusted only after selected ones of the output responses provided by quantum system 32 in response to certain ones of the pulse in the sequence of pulses. In embodiments, the same or different pulse sequences may be fed to quantum system 32 multiple times and the quantum mechanical model may be adjusted (or otherwise changed or modified) after each or only some of the output responses provided by quantum system 32 in response to one or more pulses provided thereto. An example of feedback is described below in conjunction with FIGS. 7A, 7B.

Optimizer processing system 25 comprises a quantum mechanical modeler 34, which includes a model of quantum system 32. In embodiments, the feedback from quantum system 32 is provided to the quantum mechanical model 34 to assists in optimizing the quantum control pulses over all parameters. Quantum mechanical modeler 34, may comprise one or more processors and includes or operates on a model having one or more time-dependent parameters.

In embodiments, optimizer processing system 25 further comprises one or more processors 36 for generating a Fourier representation of the time-dependent parameters of the quantum mechanical modeler. The Fourier representation is constructed to determine one or more fundamental frequencies. In embodiments, optimizer processing system 25 further comprises one or more processors 38 for forming a time-independent Hamiltonian from quantum-mechanical operators derived from the fundamental frequencies.

In embodiments, optimizer processing system 25 further comprises one or more processors 40 for processing and solving in closed form a time-independent Schrödinger equation that includes the Hamiltonian. In embodiments, optimizer processing system 25 further comprises one or more processors 42 for computing a gradient of a cost function with respect to an arbitrary number of parameters.

Examples of quantum system 32 include, but are not limited to: a quantum system having many qubits (such as a quantum computer); a quantum device; or a quantum qubit (e.g., one, two or more qubits). In practice quantum control pulses may be generated for relatively small quantum systems (e.g., systems having several qubits) and such relatively small systems may be integrated into larger systems. Thus, quantum system 32 may be any system which comprises one or more qubits. In embodiments, quantum system 32 may be any system which comprises two or more qubits couple or otherwise combined to form a device. Or even more complexly, in embodiments, quantum system 32 may comprise two or more qubits coupled or otherwise combined or arranged to form a quantum processor or to perform quantum computing.

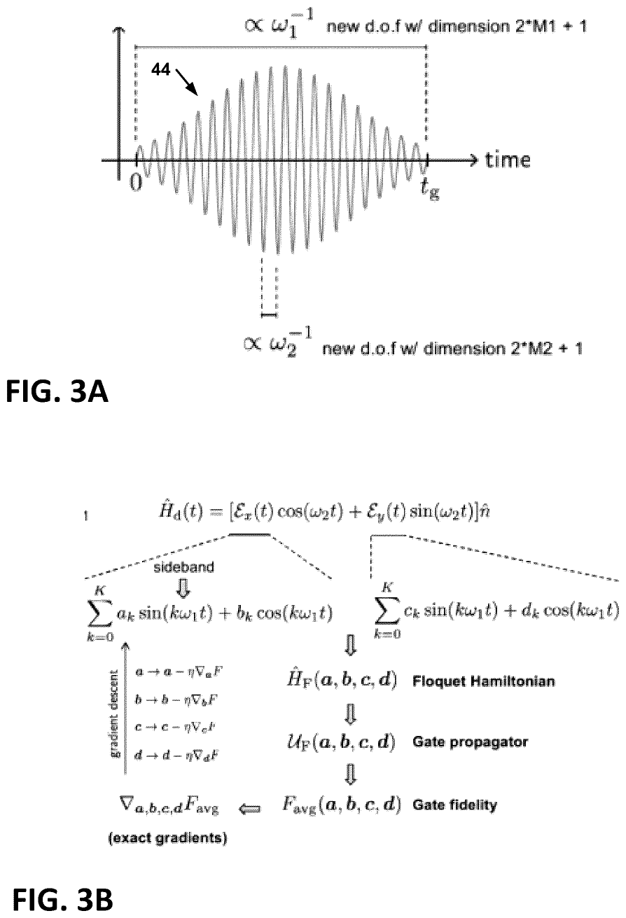

Referring now to FIGS. 3A, 3B, the techniques to optimize microwave pulses and qubit gates described in FIGS. 1 and 2 can be used, for example, to provide (or engineer) a microwave drive signal such as microwave drive 44 in FIG. 3A which also sometimes referred to herein as a “microwave drive” or a “microwave pulse” or even more simply as a “drive.” The example of FIG. 3A, illustrates a drive at a frequency ω2 (e.g., a carrier frequency), typically resonant with a system transition, and a pulse envelope here represented as a Fourier series with fundamental frequency ω1 (where ω1, ω2 are in radians). Combined, ω1 and ω2 are the frequencies of a two-tone Floquet problem representing a quantum logic gate (or more simply a “gate”).

The weights of the Fourier components of the envelope {ak, bk} (x quadrature) and {ck, dk} (y quadrature) become parameters of a two-tone Floquet Hamiltonian that can be optimized via the gradient descent loop shown in FIG. 3B.

It should, of course, be appreciated other types of gates (i.e., gates types other than the type described in FIG. 3B) may also be engineered.

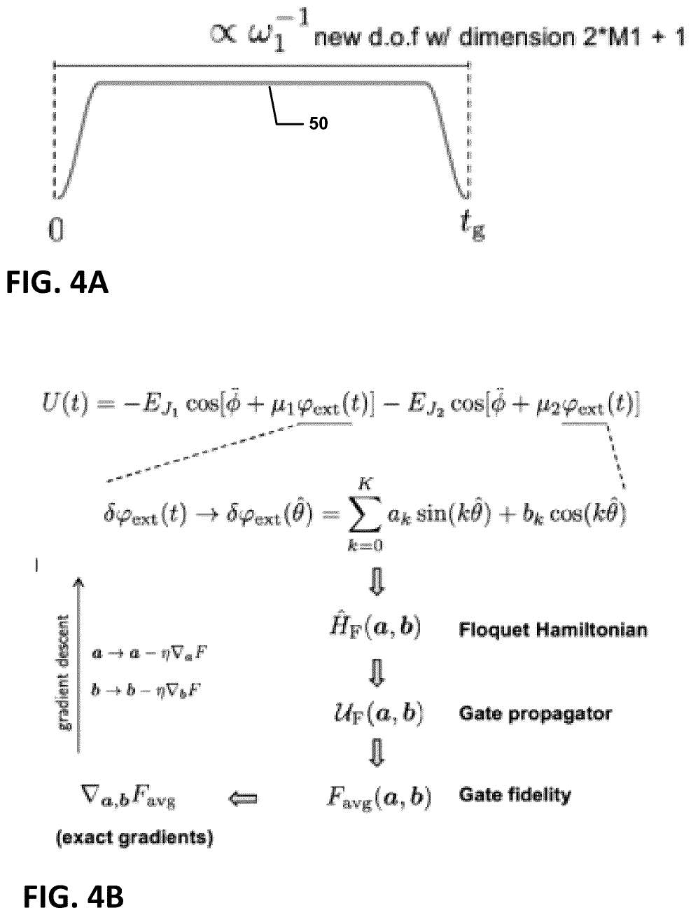

For example, and referring now to FIGS. 4A and 4B, the method described herein can be used to provide (or engineer) optimized baseband pulses and dates such as a baseband flux pulse 50 on a transmon qubit where the baseband flux pulse 50 is provided having desired characteristics. In this case, the drive frequency is ω1=2π/T, where Tis the total gate time t_{g}. As illustrated in FIG. 4B, the pulse envelope may be decomposed as a Fourier series, and the harmonic weights of such a decomposition are optimized using a gradient descent procedure.

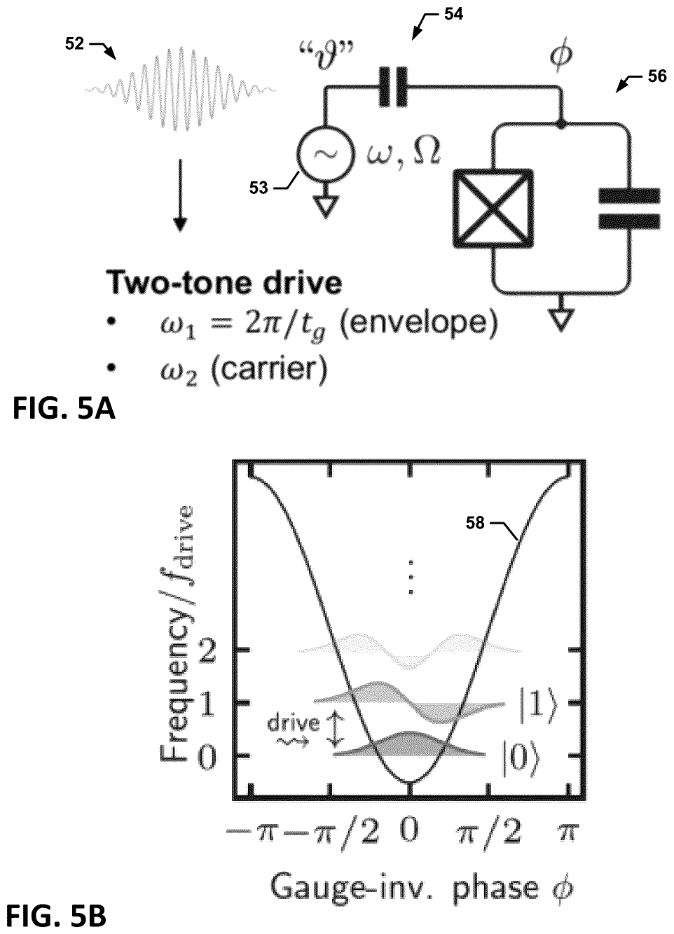

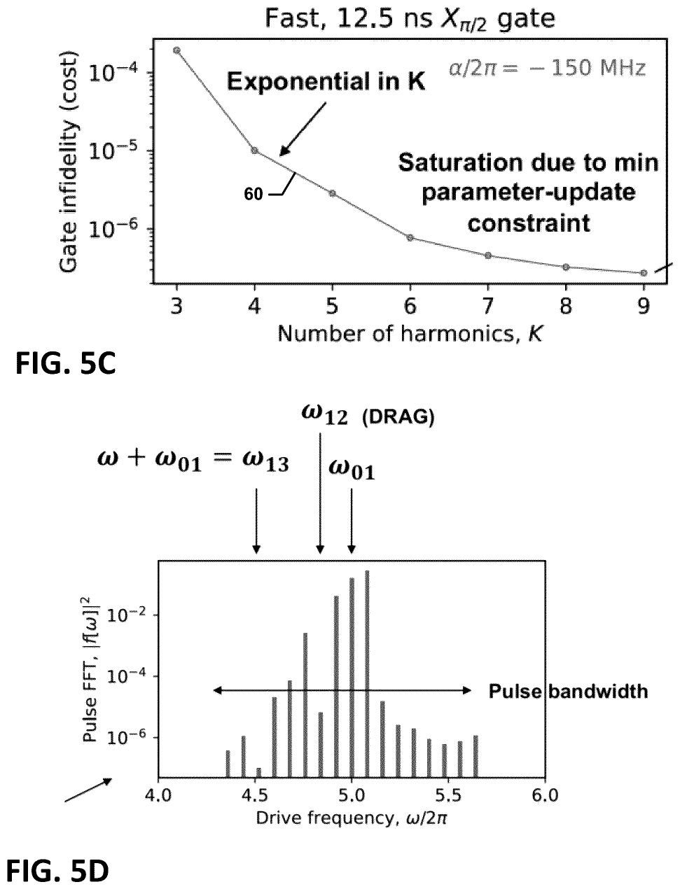

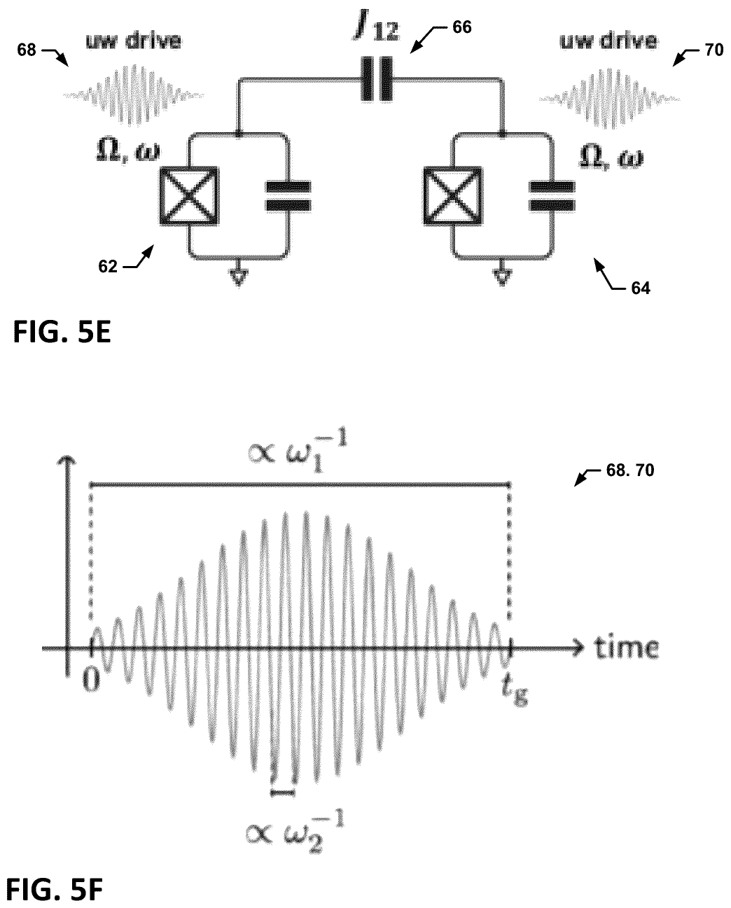

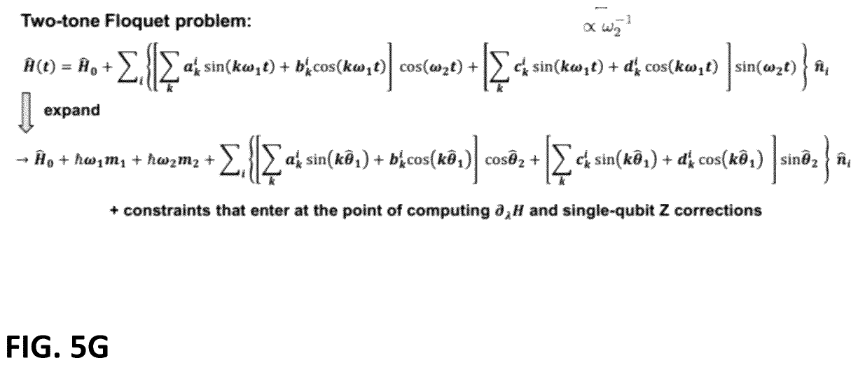

Referring now to FIGS. 5A-5D, one example of the QOC method described herein using Pi pulses is shown. As shown in FIG. 5A, a source 52 provides a two-tone drive 53 having an envelope frequency ω₁ and a carrier frequency ω₂ which may be used for gating a weakly anharmonic transmon qubit 56.

FIG. 5B is a plot of frequency/drive frequency (f_{drive}) vs. Gauge-inv phase ϕ. This figure show the transmon-qubit wavefunctions and frequencies of relevance when designing single-qubit controls.

FIG. 5C illustrates the gate infidelity as a function of the number of harmonics. As can be seen from curve 60, the gate infidelity decreases as the number of harmonics increases.

FIG. 5D is a spectral representation of a pulse (i.e. a plot of pulse FFT (|f[ω]|² vs. drive frequency (ω/2π)). FIG. 5D illustrates the amplitude of each harmonic at a given frequency. Significantly, an as can be seen, most of the power is allocated below the frequency ω₀₁ where ω₀₁ is the transition frequency of the transmon (i.e. the spectral composition is stronger below the transition frequency). Since many (and in some instances most) errors in a transmon qubit occur due to transitions (e.g. spurious transitions) that are at frequencies below the transition frequency of the transmon (e.g., ω₁₂, ω₁₃). Thus, the optimizer system and technique described herein is locating frequencies (e.g. harmonic frequencies at which spurious transitions may occur) and reducing the amount of power at those frequencies.

In particular, it should be noted in FIG. 5D that the power at ω12 (which is a leakage transition) is reduced relative to many of the other harmonics. Thus, the system and technique described herein is capable of locating frequencies at which DRAG occurs and reducing (or suppressing) the power at those frequencies (i.e., reducing or suppressing the power at those frequencies at which leakage transitions occur such as ω₁₂, ω₁₃).

Referring now to FIGS. 5E-5F, the QOC method may be applied to a microwave-activated ZZ gate. As shown in FIG. 5E, two transmon qubits 62, 64, are coupled (e.g., directly coupled) through a capacitor 66 and concurrently or simultaneously driven by two independent drives 68, 70 of the same frequency ω2 as illustrated by in FIG. 5F, for example. The envelopes of each individual drive can be decomposed as a Fourier series with fundamental frequency ω1=2π/T, where Tis the gate time.

As illustrated in FIG. 5G, by promoting the drive phases to operators, it is shown how the original time-dependent Hamiltonian may be represented as a Floquet Hamiltonian in an expanded Hilbert space.

Initialization conditions for the optimal-control method may be applied to the system of FIG. 5E. By applying a drive of constant amplitude, the ZZ interaction between the two qubits is scanned as a function of drive frequency and an operating frequency for the gate may be selected.

With this frequency selected, the ZZ interaction as a function of drive amplitude may be computed thereby allowing one to obtain an estimation of the necessary gate time to implement a CPhase gate.

With this information, the technique described herein may be initialized using the decomposition of two x-quadrature cosine pulses on qubits 52, 54c (i.e., qubit 1 and qubit 2).

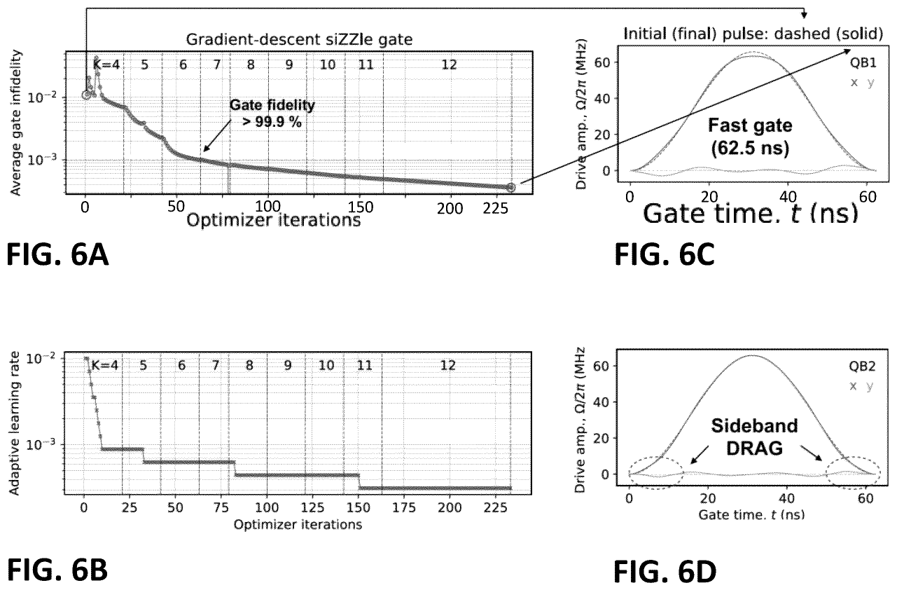

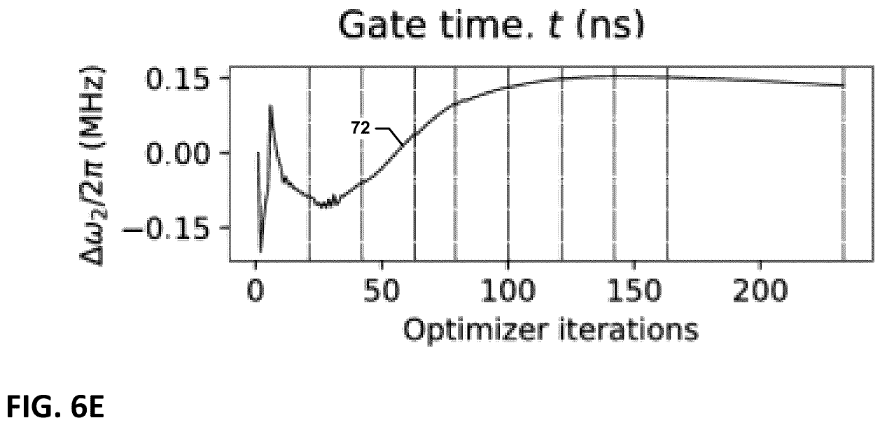

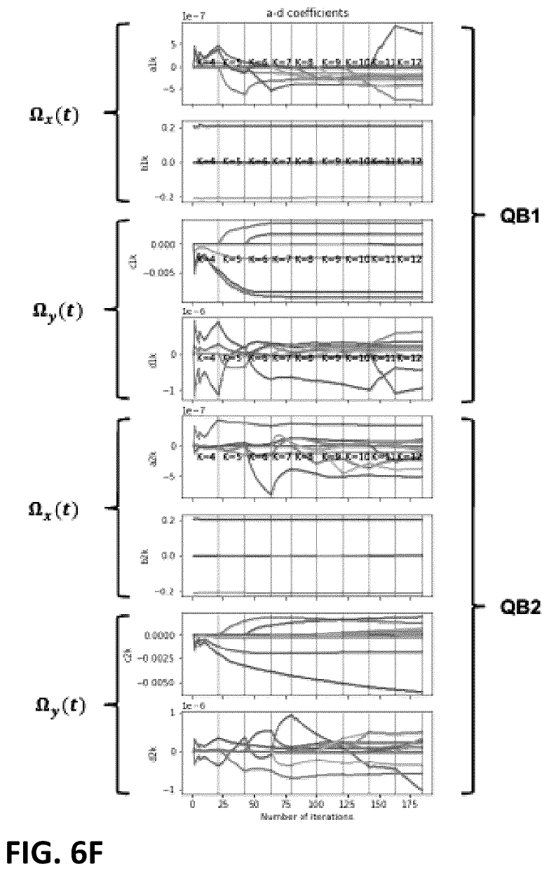

Referring now to FIGS. 6A-6E, the performance of the optimal control technique described herein is illustrated.

FIG. 6A illustrates a cost function (gate infidelity) as a function of iteration number while FIG. 6B illustrates an adaptive learning rate of gradient descent as a function of the number of iterations of an optimizer provided in accordance with the concepts and techniques described herein. As can be seen from FIG. 6A as the number of iterations increases, the cost function becomes smaller (reaching higher gate fidelities). And as can be seen from FIG. 6B, the learning-rate updates also become smaller as the number of iterations increases (and as the gate fidelity increases).

It should also be appreciated that noted that an optimizer provided in accordance with the concepts and techniques described herein may optimize over both the carrier frequency ω₂ and the gate drive frequency ω₂. (loosely corresponding to the gate time in FIGS. 6C, 6D with the example gate pulses in FIGS. 6C, 6D having gate times of about 60 ns). Thus, an optimizer provided in accordance with the concepts and techniques described herein also optimizes the time on the gate (i.e. the amount of time the gate is exposed to a pulse). Stated differently, in accordance with the concepts and techniques described herein gate time is a parameter which may be selected, changed, and/or optimized to suit the needs of a particular application. This is illustrated in the Hamiltonian shown in FIG. 5G.

This is in contrast to prior art optimizer systems in which the time on the gate is fixed and the pulse is discretized across that amount of time following which gradients are computed.

The Fourier components of the pulse envelope may be optimized with a batch structure: the first four harmonics are optimized first (K=4). This is followed by re-optimizing these four harmonics and an additional one (K=5 harmonics total). This process may be continued until reaching joint optimization of all harmonics in the problem K=12.

The differences between the initial and final pulses for the first and second qubits (i.e. QB1, QB2, respectively) are illustrated in FIGS. 6C, 6D. The dashed lines in FIGS. 6C, 6D correspond to initial conditions provided to the optimizer and the solid lines correspond to the final pulse shapes for QB1, QB 2 provided by the optimizer.

Also illustrated in FIG. 6D is the sideband DRAG. It is noted that optimization system and techniques described herein are able to optimize over the drive frequency.

FIG. 6E is an example of drive frequency optimization. Curve 72 in FIG. 6E illustrates the change in carrier frequency in MHz (expressed as Δω₂/2π) vs. the number of optimizer iterations. Curve 72 shows that the optimization system and techniques can move the drive frequency to arrive at an optimal frequency and optimal pulse shape for a given system.

FIG. 6E is an example of phase parameters (sometimes referred to as “freedom parameters”) which can be further provided as inputs to an optimizer system provided in accordance with the concepts, systems and techniques described herein to generate optimum control pulses. Other so-called freedom parameters parameter may also be sued. In view of the above, one of ordinary skill in the art should now appreciate that the optimization concepts, systems and techniques described herein can be used to optimize over all pulse parameters, freedom parameters (e.g. as shown in FIG. 6F) and even over a system Hamiltonian (i.e., all parameters may be optimized using the concepts, systems and techniques described herein).

Referring now to FIGS. 7A, 7B, in the figures above, the optimization of known two-qubit gates for transmon qubits were considered. FIGS. 7A, 7B considers a different setup involving two inductively coupled heavy fluxonium qubits 74,76. As used herein “heavy” fluxonium qubits refer to fluxonium qubits responsive to frequencies below 300 MHz such as frequencies in the range of about 50 MHz. Such qubits are sometimes referred to as low frequency qubits. Thus, typical transom gates are not well-suited for use with such low frequency qubits as transmon gates are responsive to signals having frequencies in the GHz frequency range.

Example fluxonium parameters are shown in the table below.

Fluxonium parameters (all in MHz, weak-J)

| ω₁/2Π | ω₂/2Π | α₁/2Π | α₂/2Π | J₁₂/2Π |
|---|---|---|---|---|
| 58 | 36 | >>ω₁ | >>ω₂ | 10 |

Static ZZ interaction ξ/2Π < 3 kHz

In the heavy-fluxonium regime, engineering a gate is not as straightforward as in the case of the transmon qubits, at least in part, because of the weak matrix elements of drive operators between states of the computational subspace. Thus, in this case, the optimal control technique described herein is used to “discover” a gate constructed by concatenating N smaller pulses.

Individually, these pulses perturb the two-qubit system slightly. The method described herein learns how such small perturbations should be designed and concatenated to provide (i.e. design or engineer) a maximally entangling two-qubit gate at the end of a pulse train 78 (FIG. 7B) comprising N pulses where N is an integer greater than 1. In embodiments, N may be in the range of 5-50. The learning is by gradient-descent. In particular, the pulse train is a product of exactly-differentiable factors, and thus the gradient of the pulse-train can be computed by the product rule. The result of the optimization is a pulse-train of perturbations (drives) leading to a desired target operation.

Each pulse block or unit-cell AU in pulse-train 78 comprises two single-qubit flux drives (pulses) applied simultaneously. These single-qubit pulses have an underlying periodic structure and may be written as Fourier series decomposition with fundamental frequency ω₁=2π/τ, where τ is the time of a single block. This elementary process is exactly differentiable because it admits a Floquet representation, making the process corresponding to the N concatenated pulses also differentiable by chain rule, as shown in FIG. 7B. To treat this problem, the drive phases are promoted to an operator O, and the associated Floquet Hamiltonian are solved. Net-zero constraints are incorporated in the parameter decomposition of the pulses.

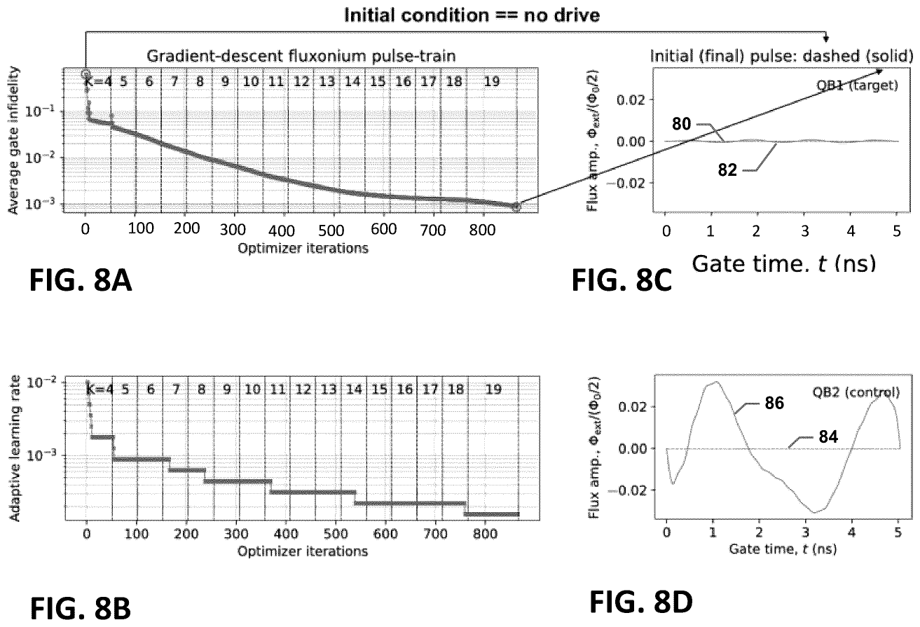

FIGS. 8A-8D illustrate results of seeking a CNOT-like pulse-train gate (transition from 2→1).

FIG. 8A is a plot of average gate infidelity vs. the number of optimizer iterations for a first one (QB1) of the pair of qubits in the system of FIG. 7A. As can be seen from the curve in FIG. 7C, gate infidelity improves as the number of optimizer iterations increases.

FIG. 8B is a plot of adaptive learning rate vs. the number of optimizer iterations for a second one (QB2) of the pair of qubits in the system of FIG. 7A. As can be seen from the curve in FIG. 8B, adaptive learning rate decreases as the number of optimizer iterations increases (and as the gate infidelity improves).

FIG. 8C is a plot of flux amplitude vs. gate time for a first one (QB1) of the pair of qubits in the system of FIG. 7A. Dashed curve 80 corresponds to the flux resulting from the initial pulse (essentially zero flux amplitude) while solid curve 82 corresponds to the optimal flux amplitude resulting from the final pulse (essentially zero flux amplitude).

FIG. 8D is a plot of flux amplitude vs. gate time for a second one (QB2) of the pair of qubits in the system of FIG. 7A. Dashed curve 84 corresponds to the flux resulting from the initial pulse (which is no pulse, in this example) while solid curve 86 corresponds to the optimal flux amplitude resulting from the final pulse.

From FIGS. 8A-8D it is understood that in the configuration of FIG. 7A, one of the qubits (i.e. QB1 which is the target, in this example) should not be driven (or driven only slightly) and the other one of the qubits (i.e. QB2 which is the control, in this example) should be driven the most. This illustrates that the systems and techniques described herein can generate a new pulse.

It is noted that compared with FIGS. 6A, 6B, many more harmonics (12 harmonics in FIGS. 6A, 6B vs. 19 harmonics in FIGS. 8A, 8B) were required to achieve a desired result (99.9% gate fidelity) in the system of FIGS. 7A, 7B thus indicating the greater complexity of the system of FIG. 7A compared with the system of FIG. 5E.

Thus, FIGS. 8A-8D illustrate the performance of the method described in FIGS. 7A, 7B with FIG. 8A illustrating initial pulses fed to an optimizer (such as optimizer 25 described above in conjunction with FIG. 2), in this case starting with zero amplitude for both qubits (i.e., no drive). FIG. 8B shows the cost function (which is average gate infidelity in this example) versus the iteration number. The envelope harmonics are optimized iteratively, making it possible to reach a gate fidelity above 99.9% in about 800 iterations.

FIG. 8C shows the adaptive learning rate evolution during the gate-fidelity optimization, and FIG. 8D shows a resulting 5-ns pulse on each qubit (single-block). In this case, the optimization targets a CNOT-like gate, where one of the qubits is a control qubit, and the other qubit is a target qubit.

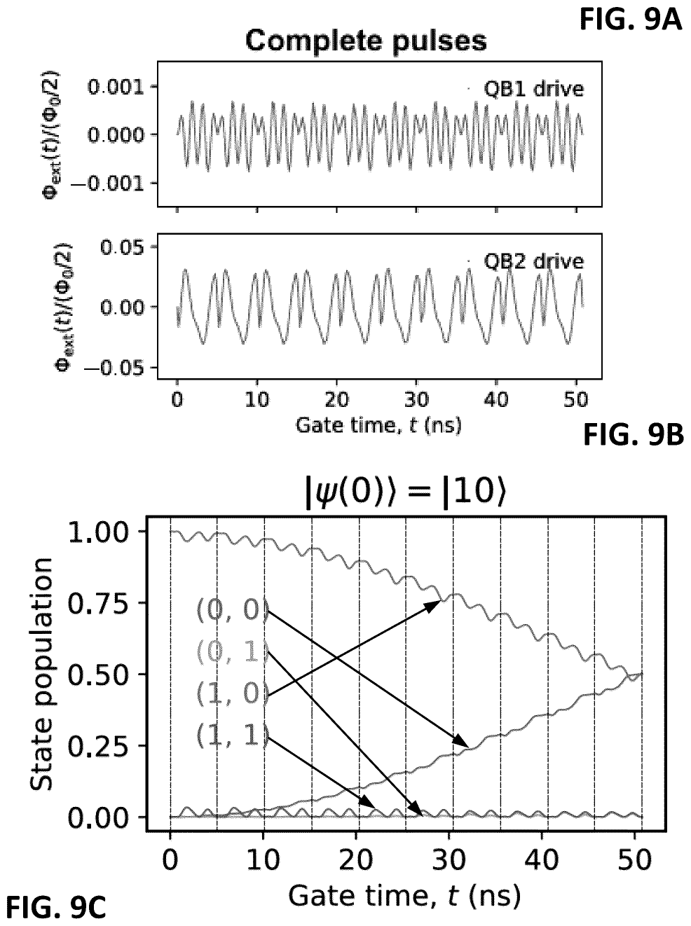

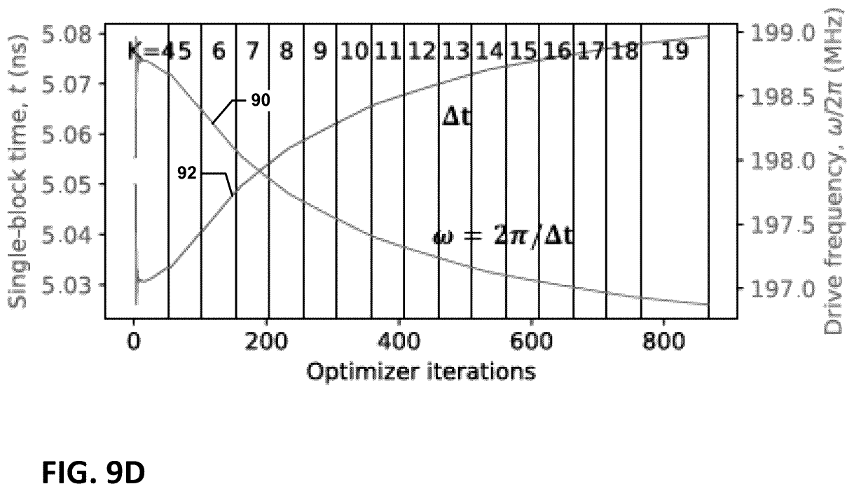

The complete pulse obtained from optimization is shown in FIG. 9A as the concatenation of the single-block pulses derived in FIGS. 7A-8D. The complete pulse train includes 10 single-block pulses (i.e., N=10) resulting in two simultaneous continuous drives (QB1 drive, QB2 drive) applied to the control and target qubits as shown in FIGS. 9A, 9B. As noted above, qubit QB1 is not driven or is driven with a very small signal while qubit QB2 is driven with a substantial signal. This behavior is alike the cross-resonance two-qubit gate, in this case being derived by the optimal control algorithm.

FIG. 9C shows the gate dynamics with the two-qubit state population as a function of time, starting from two different initial states (00) and (01), typical of a cross-resonance-like operation

In FIG. 9D, curve 90 shows the effective drive frequency (a parameter being optimized for) as a function of the iteration number while curve 92 shows the single block time. As can be seen from the figure, curve 90 shows a reduction in drive frequency as the number of iterations increases while curve 92 shows the single block time increases the number of iterations increases. Thus, this figured illustrates that the concepts, systems and techniques described herein can determine the optimal driving frequency for this two-qubit gate, which is also a measure of the total gate time.

While the state-population time-evolution shown in FIGS. 9A-9D looks like a cross-resonance gate, the effective drive frequency of pulses generated using the techniques described herein is much faster than the qubit frequencies. This may lead one to conclude that the method converged to a cross-resonance-style gate that operates differently from the known one and can therefore discover new gate implementations.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

In illustrative implementations of the concepts described herein, one or more computers (e.g., integrated circuits, microcontrollers, controllers, microprocessors, processors, field-programmable-gate arrays, personal computers, onboard computers, remote computers, servers, network hosts, or client computers) may be programmed and specially adapted: (1) to perform any computation, calculation, program or algorithm described or implied above; (2) to receive signals indicative of human input; (3) to output signals for controlling transducers for outputting information in human perceivable format; (4) to process data, to perform computations, to execute any algorithm or software, and (5) to control the read or write of data to and from memory devices. The one or more computers may be connected to each other or to other components in the system either: (a) wirelessly, (b) by wired or fiber optic connection, or (c) by any combination of wired, fiber optic or wireless connections.

In illustrative implementations of the concepts described herein, one or more computers may be programmed to perform any and all computations, calculations, programs and algorithms described or implied above, and any and all functions described in the immediately preceding paragraph. Likewise, in illustrative implementations of the concepts described herein, one or more non-transitory, machine-accessible media may have instructions encoded thereon for one or more computers to perform any and all computations, calculations, programs and algorithms described or implied above, and any and all functions described in the immediately preceding paragraph.

For example, in some cases: (a) a machine-accessible medium may have instructions encoded thereon that specify steps in a software program; and (b) the computer may access the instructions encoded on the machine-accessible medium, in order to determine steps to execute in the software program. In illustrative implementations, the machine-accessible medium may comprise a tangible non-transitory medium. In some cases, the machine-accessible medium may comprise (a) a memory unit or (b) an auxiliary memory storage device. For example, in some cases, while a program is executing, a control unit in a computer may fetch the next coded instruction from memory.

In some cases, one or more computers are programmed for communication over a network. For example, in some cases, one or more computers are programmed for network communication: (a) in accordance with the Internet Protocol Suite, or (b) in accordance with any other industry standard for communication, including any USB standard, ethernet standard (e.g., IEEE 802.3), token ring standard (e.g., IEEE 802.5), or wireless communication standard, including IEEE 802.11 (Wi-Fi®), IEEE 802.15 (Bluetooth®/Zigbee®), IEEE 802.16, IEEE 802.20, GSM (global system for mobile communications), UMTS (universal mobile telecommunication system), CDMA (code division multiple access, including IS-95, IS-2000, and WCDMA), LTE (long term evolution), or 5G (e.g., ITU IMT-2020).

Features of embodiments may take various forms of communication devices, both wired and wireless; television sets; set top boxes; audio/video devices; laptop, palmtop, desktop, and tablet computers with or without wireless capability; personal digital assistants (PDAs); telephones; pagers; satellite communicators; cameras having communication capability; network interface cards (NICs) and other network interface structures; base stations; access points; integrated circuits; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

As used herein, “including” means including without limitation. As used herein, the terms “a” and “an”, when modifying a noun, do not imply that only one of the noun exists. As used herein, unless the context clearly indicates otherwise, “or” means and/or. For example, A or B is true if A is true, or B is true, or both A and B are true. As used herein, “for example”, “for instance”, “e.g.”, and “such as” refer to non-limiting examples that are not exclusive examples. The word “consists” (and variants thereof) are to be give the same meaning as the word “comprises” or “includes” (or variants thereof).

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” ″horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the specification to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter.

In the foregoing detailed description, various features of embodiments are grouped together in one or more individual embodiments for the purpose of streamlining the disclosure. This method of disclosure is not to be interpreted as reflecting an intention that the claims require more features than are expressly recited therein. Rather, inventive aspects may lie in less than all features of each disclosed embodiment.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method comprising:
(a) modeling a quantum mechanical process having one or more time-dependent parameters;
(b) constructing a Fourier representation of the time-dependent parameters to determine one or more fundamental frequencies;
(c) forming a time-independent Hamiltonian from quantum-mechanical operators derived from the fundamental frequencies;
(d) solving, in closed form, a time-independent Schrödinger equation that includes the Hamiltonian;
(e) forming an electromagnetic pulse according to the closed-form solution, wherein the electromagnetic pulse optimizes a cost function of the time-dependent parameters; and
(f) applying the electromagnetic pulse to the quantum mechanical process, thereby altering at least one observable property of the quantum mechanical process.

2. The method of claim 1, wherein the quantum mechanical process comprises a single-qubit gate for fluxonium qubits.

3. The method according to claim 1, wherein the quantum mechanical process comprises a microwave two-qubit controlled-Z gate for transmon qubits.

4. The method according to claim 1, wherein the quantum mechanical process comprises a baseband-flux two-qubit controlled-Z gate for transmon qubits.

5. The method according to claim 1, wherein the quantum mechanical process comprises a baseband-flux two-qubit pulse-train controlled-NOT gate for fluxonium qubits.

6. The method according to claim 1, wherein forming the time-independent Hamiltonian comprises solving a Floquet problem.

7. The method according to claim 3, wherein the Floquet problem is multi-tonal.

8. The method according to claim 1, wherein solving the time-independent Schrödinger equation that includes the Hamiltonian comprises diagonalizing the Hamiltonian in an expanded Hilbert space.

9. A system comprising one or more qubit gates that are controlled using electromagnetic pulses formed and applied according to the method of claim 1.

10. A non-transitory computer-readable medium comprising instructions stored thereon, the instructions capable of being executed by a processor and comprising:
constructing a Fourier representation of the time-dependent parameters to determine one or more fundamental frequencies;
forming a time-independent Hamiltonian from quantum-mechanical operators derived from the fundamental frequencies;
solving, in closed form, a time-independent Schrödinger equation that includes the Hamiltonian;
forming an electromagnetic pulse according to the closed-form solution, wherein the electromagnetic pulse optimizes a cost function of the time-dependent parameters; and
applying the electromagnetic pulse to the quantum mechanical process, thereby altering at least one observable property of the quantum mechanical process.

11. The non-transitory computer-readable medium of claim 10, wherein the quantum mechanical process comprises a single-qubit gate for fluxonium qubits.

12. The non-transitory computer-readable medium of claim 10, wherein the quantum mechanical process comprises a microwave two-qubit controlled-Z gate for transmon qubits.

13. The non-transitory computer-readable medium of claim 10, wherein the quantum mechanical process comprises a baseband-flux two-qubit controlled-Z gate for transmon qubits.

14. The non-transitory computer-readable medium of claim 10, wherein the quantum mechanical process comprises a baseband-flux two-qubit pulse-train controlled-NOT gate for fluxonium qubits.

15. The non-transitory computer-readable medium of claim 10, wherein forming the time-independent Hamiltonian comprises solving a Floquet problem.

16. The non-transitory computer-readable medium of claim 15, wherein the Floquet problem is multi-tonal.

17. The non-transitory computer-readable medium of claim 10, wherein solving the time-independent Schrödinger equation that includes the Hamiltonian comprises diagonalizing the Hamiltonian in an expanded Hilbert space.

18. The non-transitory computer-readable medium of claim 10 wherein one or more qubit gates that are controlled using the formed electromagnetic pulses are applied to a system.
